(19) United States
(12) Patent Application Publication
(10) Pub. No.: US 2009/0314217 A1
(43) Pub. Date: Dec. 24, 2009

(54) APPARATUS AND METHOD FOR TREATING NON-HUMAN MAMMALS

(75) Inventors: Gary Oscar Hurwitz, Pretoria (ZA); André Hugo Smith, Pretoria (ZA); Louwrens Jakobus Briel, Pretoria (ZA); Rensia De Wet, Pretoria-Oos (ZA)

Correspondence Address: BROOKS KUSHMAN P.C., 1000 TOWN CENTER, TWENTY-SECOND FLOOR, SOUTHFIELD, MI, 48075, US

(73) Assignee: Under The Boardwalk Properties 8 (Proprietary) Limited, Pretoria (ZA)

(21) Appl. No.: 12/440,768

(22) PCT Filed: Sep. 10, 2007
(86) PCT No.: PCT/IB07/53637

§ 371 Date: Mar. 11, 2009

(30) Foreign Application Priority Data
Sep. 11, 2006 (ZA) 2006/07595

(51) Int. Cl. A01K 1/03; B60P 3/04

(52) U.S. Cl. 119/400; 119/420

(57) ABSTRACT

Apparatus for treating non-human quadruped mammals includes an enclosure having an interior within which the body of a mammal can be located. The enclosure has an opening through which the head of the mammal can pass so that the mammal's head can be located outside the enclosure when the mammal's body is inside the enclosure. The enclosure is sized to allow the mammal to stand normally on its four legs inside the enclosure during treatment, or to lie down inside the enclosure during treatment. The apparatus further includes a steam generator and an ozone generator or supply arranged to feed steam and ozone into the enclosure.

THIS INVENTION relates to the treatment of non-human mammals. In particular, the invention relates to apparatus for treating non-human quadruped mammals, and to a method of treating non-human quadruped mammals.

According to one aspect of the invention, there is provided apparatus for treating non-human quadruped mammals, the apparatus including

an enclosure having an interior within which the body of a mammal can be located, the enclosure having an opening through which the head of the mammal can pass so that the mammal's head can be located outside the enclosure when the mammal's body is inside the enclosure, and the enclosure being sized to allow the mammal to stand normally on its four legs, or to lie down, inside the enclosure during treatment;

a steam generator arranged to feed steam into the enclosure; and

an ozone generator or supply arranged to feed ozone into the enclosure.

In one embodiment of the invention, the enclosure is sized to allow the mammal, e.g. a horse, to stand normally on its four legs inside the enclosure during treatment. In another embodiment of the invention, the enclosure is sized to allow the mammal, e.g. a camel, to lie down inside the enclosure during treatment.

Preferably, the apparatus includes a displaceable barrier or closure operable to fit around the neck of the mammal to screen off the interior of the enclosure from the mammal's head, thereby inhibiting inhaling of ozone by the mammal.

The barrier or closure may be of a flexible material, and may comprise a curtain. When the barrier or closure comprises a curtain, the curtain may include two portions that are separated at least partially about an upwardly extending line. The curtain may include a fastener to fasten the portions of the curtain together above and/or below the neck of a mammal being treated. Examples of suitable fasteners include press-studs, buttons and hook-and-loop fasteners.

The enclosure may include a door at an end thereof to admit a mammal to be treated. The door may be located in an opening sized and configured to allow a large mammal, such as a horse, to walk into the enclosure.

The enclosure may include a displaceable roof to admit a quadruped mammal of the kind that usually walks with its head elevated above its shoulders, e.g. an equid. The displaceable roof may be hingedly attached to a side of the enclosure to pivot about a substantially horizontal axis. In one embodiment of the invention, the displaceable roof comprises two curved roof portions, each portion being hingedly attached to an associated side of the enclosure.

The enclosure may be sized to accommodate a standing adult horse.

The enclosure may be housed within a closeable housing. At least some walls of the closeable housing may be spaced from the enclosure to define component spaces within which components of the apparatus may be located.

The enclosure may be supported on a wheeled chassis, rendering the apparatus mobile. The apparatus may be in the form of a mobile horsebox. More particularly, the closeable housing may be in the form of a mobile horsebox. A drop down door or ramp door of the horsebox may lead up to the door of the enclosure, when the drop down door is in an open condition.

The steam generator may include at least one water reservoir and at least one boiler or kettle to generate steam. The water reservoir and the steam kettle may be located between the enclosure and the housing, in a portion of the component space.

The steam generator may include at least one steam inlet at a low elevation inside the enclosure in use to feed steam at a low elevation below the body of the mammal into the enclosure. When the enclosure is configured for an equid, the or each steam inlet is preferably at an elevation of less than 15 cm above a floor of the enclosure.

Preferably, the steam generator includes at least one steam inlet in each of two opposed side walls of the enclosure.

The steam generator may include a temperature controller operable automatically to control the temperature inside the enclosure by manipulating the flow of steam into the enclosure. Typically, the steam controller includes at least one temperature sensor inside the enclosure. The temperature sensor is preferably located at a high elevation inside the enclosure so that in use the temperature sensor is above the body of the mammal inside the enclosure.

The ozone generator may include a supply of oxygen and at least one ozone inlet at a high elevation inside the enclosure to feed ozone into the enclosure. Preferably, the ozone inlet is located such that in use the ozone inlet is above the body of the mammal inside the enclosure.

If desired, the ozone generator may include an ozone controller operable automatically to control the concentration of ozone inside the enclosure by manipulating the flow of ozone into the enclosure. Instead, the ozone generator may include a manually set flow control valve manually to set the ozone flow into the enclosure at a constant flow rate.

The apparatus may include a holder for animal feed, fodder or the like located in the vicinity of the opening in the enclosure through which the head of the mammal can pass.

The apparatus may include at least one infra-red or far infra-red light source inside the enclosure, in use to illuminate the mammal's body with infra-red or far infra-red light.

The apparatus may include sprayers inside the enclosure in flow communication with a source of ozonated water to spray ozonated water on the body of the mammal.

According to another aspect of the invention, there is provided a method of treating a non-human quadruped mammal, the method including

locating the mammal's body in an enclosure such that the mammal is standing on its four legs, or is lying down, and the mammal's head is outside the enclosure and screened or sealed from the enclosure;

heating an interior of the enclosure with steam; and

feeding ozone into the heated enclosure for a treatment period thereby providing the mammal with transdermal ozone therapy.

In one embodiment of the invention, the animal, e.g. a horse, is standing on its four legs inside the enclosure. In another embodiment of the invention, the animal, e.g. a camel, is lying down inside the enclosure.

The method may include preheating the enclosure with steam prior to locating the mammal's body inside the enclosure.

The steam is typically saturated steam at atmospheric pressure.

The mammal may be an equid, e.g. a horse.

The interior of the enclosure may be heated to a temperature of at least about 39° C., preferably to a temperature of at least about 41° C., more preferably to a temperature of at least about 43° C.

The interior of the enclosure may be heated to a temperature of less than about 50° C., preferably to a temperature of less than about 49° C., more preferably to a temperature of less than about 48° C., e.g. to a temperature between about 43° C. and about 47° C.

When the mammal is an equid, the method may include raising a surface body temperature of the equid to a temperature of between about 37° C. and about 41° C., preferably between about 38° C. and about 41° C., more preferably between about 39° C. and about 40.5° C., e.g. between about 39.5° C. and about 40.5° C. Typically, the surface body temperature is measured on the back of the equid, more specifically at the point of the shoulder of the equid.

The treatment period may be between about 20 minutes and about 60 minutes, preferably between about 25 minutes and about 50 minutes, more preferably between about 30 minutes and about 45 minutes, e.g. about 38 minutes.

The method may include illuminating the mammal's body inside the enclosure with infra-red or far infra-red light.

The method may include spraying ozonated water on the body of the mammal.

The invention will now be described, by way of example only, with reference to the accompanying diagrammatic drawings in which:

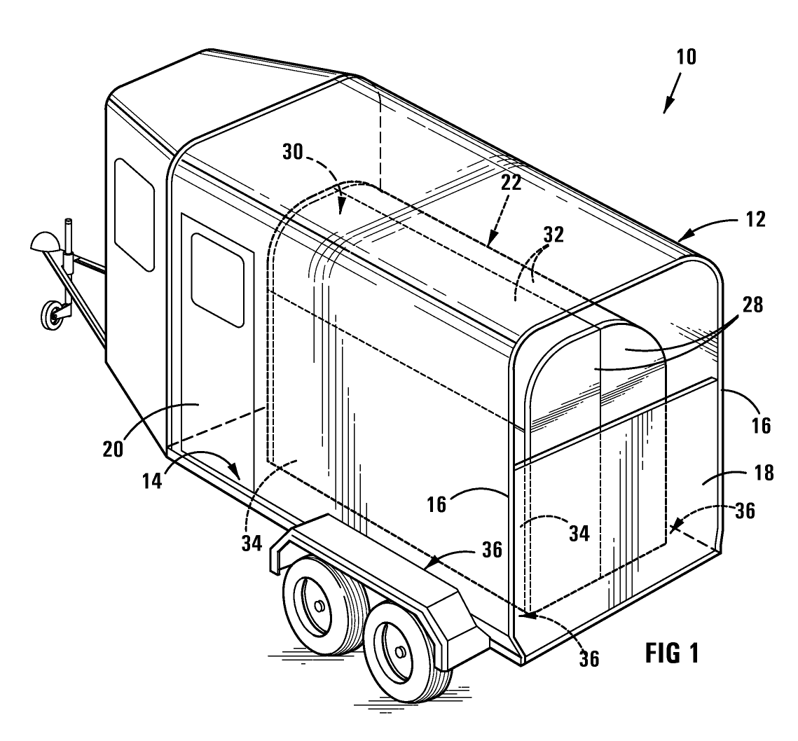

FIG. 1 shows a three-dimensional view of one embodiment of apparatus in accordance with the invention for treating non-human quadruped mammals;

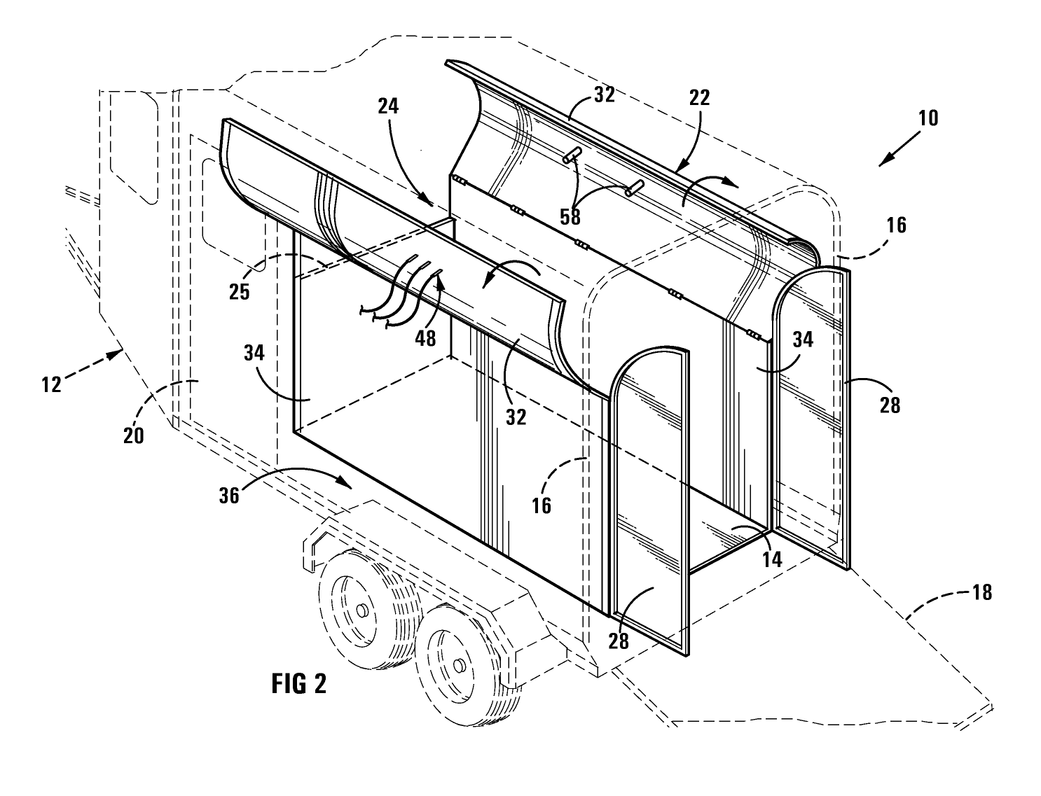

FIG. 2 shows a three-dimensional view of the apparatus of FIG. 1, opened to admit a horse for treatment;

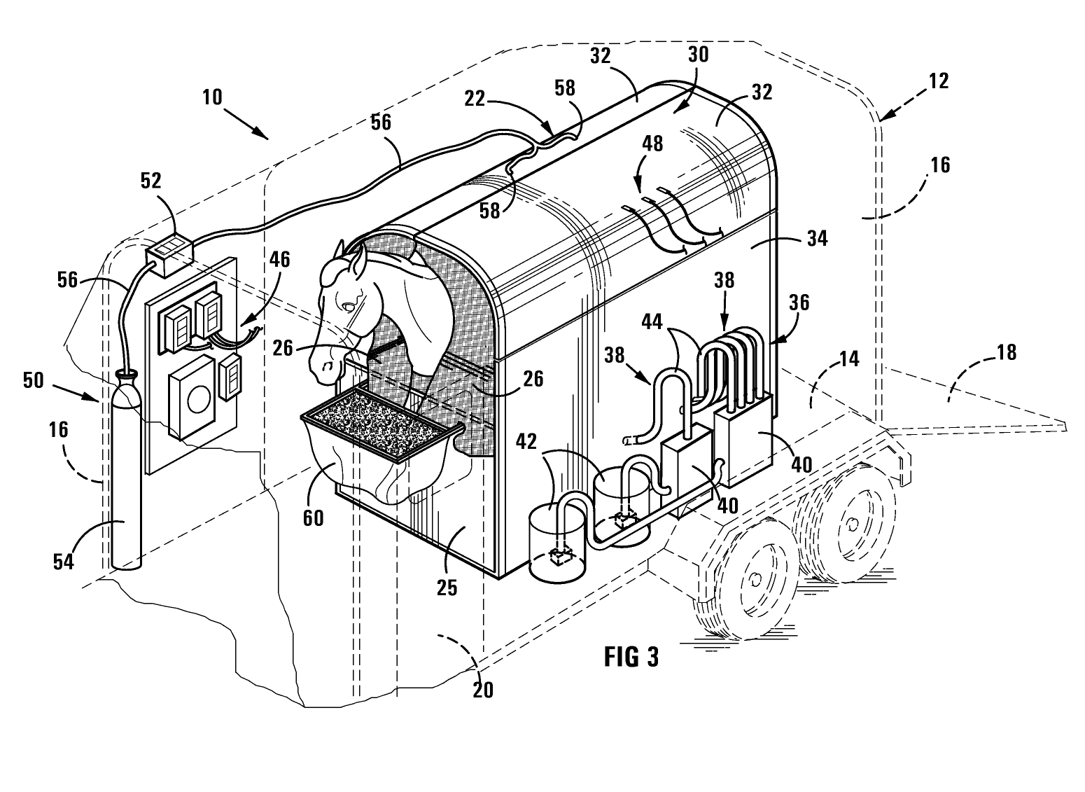

FIG. 3 shows a three-dimensional view of the apparatus of FIG. 1, being used to treat a horse;

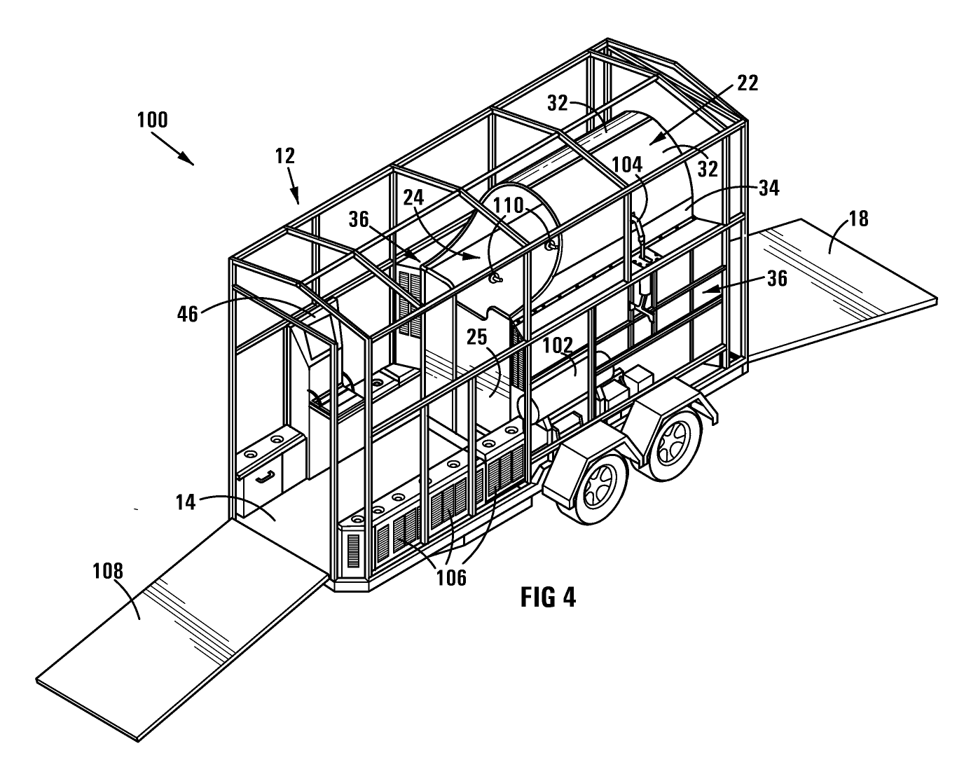

FIG. 4 shows a three-dimensional view of another embodiment of apparatus in accordance with the invention for treating non-human quadruped mammals, with wall portions or panels omitted for illustrative purposes; and

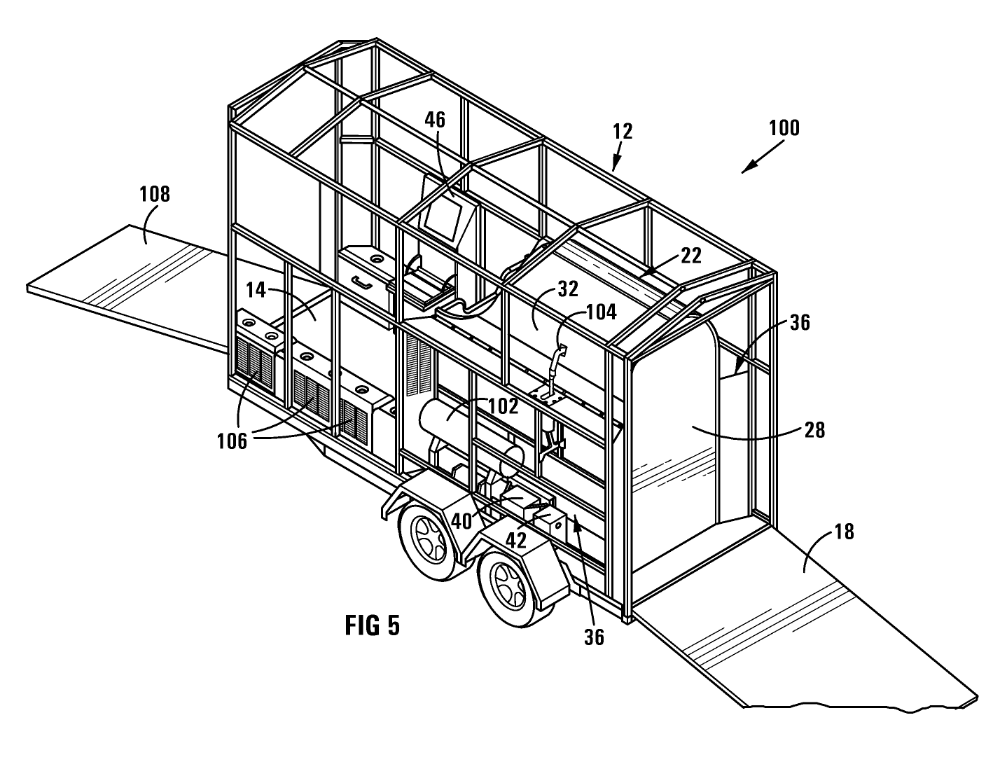

FIG. 5 shows another three-dimensional view of the apparatus of FIG. 4.

Referring to the drawings, reference numeral 10 generally indicates apparatus in accordance with the invention for treating non-human quadruped mammals, in particular equids, transdermally with ozone. The apparatus 10 includes a closeable, wheeled housing in the form of a mobile horsebox 12 comprising a floor 14, side walls 16, a rear ramp door 18 and a doorway 20. In the embodiment of the invention as illustrated in the drawings, the apparatus 10 thus includes a wheeled chassis, rendering the apparatus 10 mobile. It is however to be appreciated that the apparatus 10 may be in the form of a permanent installation and does not necessarily have to be mobile.

Inside the horsebox 12, an enclosure or pod 22 is provided. The enclosure 22 is large enough to accommodate a standing mature thoroughbred horse and has an opening 24 (see FIG. 2) above a front door 25 through which the head of a horse can pass so that the horse's head is located outside the enclosure 22 when the horse is standing with its body inside the enclosure 22. A barrier or closure of a flexible material, in the form of a split curtain 26 (see FIG. 3) hangs in the opening 24. The split curtain 26 can fit around the neck of a horse to screen off the interior of the enclosure 22 from the horse's head, thereby inhibiting inhaling of ozone by the horse during treatment. Typically, the split curtain includes fasteners, e.g. press studs or buttons, to fasten portions of the curtain below the neck of the horse together. These fasteners are not shown in the drawings.

The enclosure 22 includes a hinged double door 28 at the rear of the enclosure 22, facing the ramp door 18. It will thus be noted that a horse can be led into the enclosure 22 by dropping the ramp door 18 and by opening the double door 28, thereby providing an access opening sufficiently large to admit a horse up the ramp defined by the ramp door 18 and into the enclosure 22.

The enclosure 22 includes a displaceable roof 30. The displaceable roof 30 comprises two upwardly curved roof portions 32 each of which is hingedly attached to an associated side 34 of the enclosure 22. As can be clearly seen in FIG. 2 of the drawings, the roof portions 32 can be hingedly opened up to provide sufficient head clearance for a horse to walk into the enclosure 22. Once the horse is inside the enclosure 22, the roof portions 32 can be hingedly displaced again to form the roof 30 and thus a fairly snug enclosure for the body of the horse.

The sides 34 of the enclosure 22 are spaced from the side walls 16 of the mobile horsebox 12 thereby to define component spaces 36 adjacent the enclosure 22 within which components of the apparatus 10 are located. In the embodiment of the invention illustrated in the drawings, these components of the apparatus 10 include steam generators 38 to generate steam for feeding into the enclosure 22. As will be appreciated, the configuration and number of steam generators 38 can vary according to requirements and the capacity of each steam generator. In the embodiment of the invention shown in the drawings, and in particular in FIG. 3, there are two steam generators 38 on one side of the enclosure 22 and three steam generators on the other side of the enclosure 22 (not shown). Each steam generator 38 comprises a kettle or boiler 40 and a water reservoir 42. The kettles 40 are electrically operated kettles. Water from the water reservoirs 42 is pumped into the kettles 40 under automatic level control to ensure that the kettles 40 do not run dry.

Steam inlets 44 lead from the kettles 40 through the sides 34 into the enclosure 22. The steam inlets 44 enter the enclosure 22 at an elevation of about 15 cm above the floor 14. Typically, the steam inlets 44 are located such that they would be between the front and hind legs of a horse standing inside the enclosure 22, thereby blowing steam in use into the space underneath the body of the horse, between the front and hind legs of the horse. Steam inlets 44 are provided in both sides 34 of the enclosure 22.

A temperature controller 46 is provided to control the temperature inside the enclosure 22 by manipulating the flow of steam from the kettles 40 into the enclosure 22. As shown in FIG. 2 of the drawings, thermocouples 48 extend through one of the roof portions 32 in use to be located inside the enclosure 22. The thermocouples 48 are in communication with the temperature controller 46. During use, the thermocouples 48 are located above the body of the horse inside the enclosure 22.

The apparatus 10 further includes an ozone generator 50 comprising an electrically operated ozonator 52 and a supply of oxygen 54. A conduit 56 leads from the oxygen supply 54 into the ozonator 52 and from the ozonator 52 into the enclosure 22, through two ozone inlets 58 in one of the roof portions 32. In the embodiment of the invention illustrated in the drawings, a constant flow rate of oxygen from the oxygen supply 54 is set manually by a flow control valve (not shown) and converted by the ozonator 52 into ozone, thereby ensuring a constant flow rate of ozone into the enclosure 22 through the ozone inlets 58. As will however be appreciated, it is also possible to configure the ozone generator 50 to operate automatically to control the concentration of ozone inside the enclosure 22 by manipulating the flow of ozone into the enclosure 22. Such an arrangement will however require an ozone sensor located inside the enclosure 22. It is also possible to replace the oxygen supply 54 with an oxygen concentrator (not shown) in order to manufacture oxygen to supply oxygen to the ozonator 52.

Although not shown in the drawings, infra-red or far infra-red lights are provided inside the enclosure 22 allowing one to apply infra-red or far infra-red therapy to the muscles of a horse located inside the enclosure 22.

The apparatus 10 includes a holder 60 for fodder, e.g. lucerne or something equally tasty for a horse to nibble on to help the horse relax during treatment.

In order to use the apparatus 10 to provide a horse with transdermal ozone therapy, the apparatus 10 is towed like a normal horsebox to an appropriate location. Electrical power is supplied to the apparatus 10 and all of the electrical equipment is switched on. If necessary, the water reservoirs 42 are filled and the interior of the enclosure 22 is preheated by feeding steam from the kettles 40 into the enclosure 22. Typically, the enclosure 22 is preheated to a temperature of about 39° C. Once the interior of the enclosure 22 has reached the desired preheat temperature, the steam generators 38 are switched off, the ramp door 18 is lowered if not yet done, the roof portions 32 are opened up as shown in FIG. 2 and then the double door 28 is opened. A horse is then led into the enclosure 22 as if into a normal horsebox. Once the horse is inside the enclosure 22, the double door 28 is first closed, allowing a bit of time for the horse to become familiar with the environment. Once the horse has settled, the roof portions 32 are closed slowly, one at a time. Thereafter, the split curtain 26 is closed around the horse's neck and chest to seal the horse's head from the interior of the enclosure 22. This should be done slowly to ensure that the horse remains calm and settled.

The steam generators are again activated to raise the temperature of the interior of the enclosure. Once the interior of the enclosure has reached a temperature of about 39° C., flow of oxygen from the oxygen supply 54 to the ozonator 52 is established. A typical oxygen flow rate would be between about 1 l/min and about 10 l/min. The temperature controller 46 is set to control the temperature inside the enclosure within a range of between about 43° C. and about 47° C. The horse is then left to steam inside the enclosure 22 for a desired treatment period, typically between about 20 minutes and about one hour. Before leaving the horse, one should make sure that there is something available for the horse to nibble on in the holder 60 to keep the horse busy throughout the treatment period.

When the treatment session has finished, the ozonator 52 is switched off and the flow of oxygen from the oxygen supply 54 is closed. The steam generators 38 are then switched off and the split curtain 26 is opened. The front door 25 of the enclosure 22 is unlatched so that a horse handler is able to walk out with the horse once the double door 28 has been opened. The roof portions 32 are opened up whereafter the double door 28 is opened up, allowing the horse to disembark from the enclosure 22 and the horsebox 12 as the horse would a normal horsebox. A sweat sheet for effective evaporation and cooling or a blanket should be placed over the horse directly after treatment to prevent chill.

Referring to FIGS. 4 and 5 of the drawings, reference numeral 100 indicates another embodiment of apparatus in accordance with the invention for treating quadruped mammals, and in particular horses. The apparatus 100 is similar to the apparatus 10 and unless otherwise indicated, the same reference numerals are used to indicate the same or similar parts or features.

The apparatus 100 includes a compressed air tank 102 from which compressed air can be provided to power pneumatic devices, e.g. to open and close doors or roof portions, such as the roof portion 32 which is displaced by means of a mechanical arm 104. As will however be appreciated, the compressed air tank 102 can be omitted if desired, with actuation or displacement of components such as doors being effected electrically.

The apparatus 100 includes air conditioners 106 for cooling a forward part of the mobile horse box 12 in which a human operator would in use be working, as well as the head of the horse being treated.

Unlike the apparatus 10, the apparatus 100 includes a front ramp door 108, allowing a horse to walk forwardly from the pod 22 and out of the apparatus 100.

Although not shown in FIGS. 4 and 5, the apparatus 100 preferably includes guard railings to ensure that a horse walking up the ramp 18 or down the ramp 108 does not misstep. Typically, the guard railings at the rear of the horse box 12 are located inside the horsebox 12 and slide in and out in a plane parallel to the side walls 16. Typically, the guard rails at the front of the horsebox 12 are hingedly attached to the side walls of the horsebox 12 and hinge open and closed so that when the ramp door 108 is closed, the guard rails are located immediately behind the closed ramp door 108.

Also not shown in FIGS. 4 and 5, is neoprene padding which is placed on guard rails and other sharp edges and corners to protect a horse when entering or leaving the apparatus 100, or during treatment inside the apparatus 100.

The apparatus 100 includes ozonated water sprayers 110 for spraying ozonated water on the body of a horse being treated inside the pod 22. The ozonated water sprayers are attached to a supply of water. A venturi is used to suck ozone from the ozone generator into the water before the water is sprayed through the sprayers 110 onto the horse. Typically, about five sprayers 110 are used on each side of a horse to spray water onto the front and rear legs, the shoulders and buttocks and the body of the horse.

The apparatus 10 is used in similar fashion to the apparatus 100, but is expected to be easier to use due to, inter alia, the presence of the front ramp door 108.

The apparatus 10 was used in a confidential trial to treat five horses taking part in an endurance race. The five horses were called Moniq, Shamon, Pauli, Viola and Ophelia. During treatment, the average temperature inside the enclosure 22 was between 42° C. and 45° C. and an oxygen flow rate of 1 l/min was supplied to the ozonator 52. During treatment, the average heart-rate for the non-accustomed horses was 42 beats per minute. The superficial skin temperature measured on the neck and the point of the shoulder of the horses was 39° C. in each case. During treatment, the respiration of the horses increased, but none of the horses appeared to be uncomfortable during the treatment.

Moniq showed lumbar muscle spasms during day 1 of the race and got motion 1 throughout the day. She was seen by a physiotherapist on the first day to confirm lumbar spasms. On day 1 and day 2, she was treated in the apparatus 10 and continued the rest of the ride with no motion marks. The physiotherapist could find no muscle spasms on day 2 or day 3 of the race. The horse's creatine kinase lowered from 3873 to 706 and the rider finished in the top 25.

The horse Shamon showed severe fatigue by day 2 of the race and was treated in the afternoon. The horse rode very well on the third day of the race and finished in the fifteenth position. The rider said the horse felt strong during day 3 after treatment with the apparatus 10.

The mare Pauli received pre-treatments before the race. She had a history of gluteal muscle spasms, increased heart-rate and late tying up on two previous South African national endurance rides, always falling out on the second day. After the pre-treatment with the apparatus 10, she finished fourteenth overall, had no motion marks or stiffness and performed great throughout the race, receiving the trophy for the fastest Arab part-bred to finish the race.

The mare Viola presented with “tying up” on the first day of the race and received motion marks. She was treated on the first and second day of the race in the apparatus 10 and the horse finished the ride in the top 35. The owner reported that the horse felt much stronger and looser on the second and third days of the race. The horse's creatine kinase lowered from 5896 to 1599 IU/K and the aspertine amino transferase from more than 2000 to 1814 U/L.

The horse Ophelia presented with high haematocrit post-ride on the first day of the race, and was dehydrated and fatigued. She was treated in the apparatus 10 after the first day and after the second day of the race. She finished in the top juniors and the rider reported that the mare felt very strong and consistent on the second and third days of the race, and was drinking well.

Table 1 provides information on the blood tests conducted on the five horses, on the days of the race as indicated.

TABLE 1
BLOOD TESTS

| | MONIQ | MONIQ | MONIQ | PAULI | SHAMON | VIOLA | VIOLA | OPHELIA |
|---|---|---|---|---|---|---|---|---|
| | DAY 1 | DAY 2 | DAY 3 | DAY 2 | DAY 3 | DAY 1 | DAY 2 | DAY 1 |
| WBC | 12.8 | 9.56 | 9.56 | 19.8 | 15.8 | 15.0 | 13.1 | 20.4 |
| LYM | 1.80 | 1.96 | 1.06 | 1.39 | 2.59 | 1.34 | 2.14 | 1.36 |
| MON | 0.57 | 0.06 | 0.06 | 0.80 | 0.82 | 0.64 | 0.56 | 0.17 |
| GRA | 10.5 | 7.55 | 7.55 | 17.6 | 12.4 | 13.0 | 10.4 | 18.8 |
| LY % | 14.0 | 20.5 | 20.5 | 7.0 | 16.4 | 8.9 | 16.3 | 6.7 |
| MON % | 4.4 | 0.6 | 0.6 | 4.0 | 5.2 | 4.3 | 4.3 | 0.9 |
| GR % | 81.6 | 78.9 | 78.8 | 88.0 | 78.4 | 86.8 | 79.4 | 92.5 |
| RBC | 10.2 | 9.21 | 9.21 | 10.5 | 7.56 | 9.73 | 9.03 | 10.8 |
| HB | 15.5 | 13.6 | 17.0 | 16.6 | 11.9 | 15.2 | 14.4 | 18.4 |
| HCT | 38.7 | 34.3 | 34.3 | 42.8 | 30.2 | 38.6 | 36.9 | 47.4 |
| MCV | 38 | 37 | 37 | 41 | 40 | 40 | 41 | 44 |
| MCH | 15.1 | 14.7 | 14.7 | 15.8 | 15.8 | 15.7 | 16.0 | 16.9 |
| MCHC | 40.0 | 39.6 | 39.6 | 38.8 | 39.3 | 39.4 | 39.0 | 38.7 |
| RDWc | 22.5 | 22.2 | 22.2 | 21.9 | 22.1 | 22.4 | 22.6 | 22.3 |
| PLT | 83 | 124 | 127 | 110 | 102 | 146 | 99 | 157 |
| PCT | 0.04 | 0.07 | 0.07 | 0.05 | 0.06 | 0.09 | 0.05 | 0.09 |
| MPV | 4.8 | 5.7 | 5.7 | 5.0 | 5.7 | 6.0 | 4.9 | 6.0 |
| PDW | 32.6 | 37.2 | 37.2 | 33.8 | 35.8 | 35.8 | 31.0 | 35.8 |
| Na+ | 139 | 137 | 137 | 143 | 138 | 144 | 138 | 141 |
| K+ | 4.4 | 4.3 | 4.3 | 5.1 | 3.8 | 5.1 | 3.7 | |
| CO2 | 27 | 27 | 27 | 26 | 29 | 27 | 29 | 25 |
| CK | 3873 | 706 | 706 | 1378 | 1450 | 5896 | 1599 | 985 |
| GLU | 4.7 | 6.1 | 6.1 | *6.9 | 6.3 | 2.9 | 5.7 | 2.7 |
| CA++ | 2.98 | 2.98 | 2.98 | 3.13 | 2.76 | 2.97 | 2.88 | 3.16 |
| BUN | 8 | 9 | 9 | 9 | 9 | 9 | 9 | 10 |
| CRE | 96 | 106 | 106 | 129 | 122 | 131 | 99 | 85 |
| AST | 468 | 564 | 564 | 379 | 722 | >2000 | 1814 | 373 |
| TBIL | 37 | 58 | 58 | 96 | 52 | 41 | 48 | 31 |
| GGT | 12 | 11 | 11 | 19 | 27 | 17 | 18 | 15 |
| ALB | 36 | 34 | 34 | 32 | 31 | 34 | 30 | 33 |
| TP | 79 | 75 | 75 | 79 | 66 | 75 | 69 | 79 |
| GLOB | 43 | 40 | 40 | 47 | 35 | 40 | 39 | 47 |

In Table 1, the abbreviations used in the first column indicate the following, with the measurements being in the units of measure as indicated below:
WBC = WHITE BLOOD CELL COUNT (×10\hat{ }9/liter)
LYM = LYMPHOCYTES (×10\hat{ }9/liter)
MON = MONOCYTES (×10\hat{ }9/liter)
GRA = GRANULOCYTES (×10\hat{ }9/liter)
LY % = LYMPHOCYTES PERCENTAGE
MON % = MONOCYTES PERCENTAGE
GR % = GRANULOCYTES PERCENTAGE
RBC = RED BLOOD CELL COUNT (×10\hat{ }12/liter)
HB = HEMOGLOBIN (d/deciliter)
HCT = HEMATOCRIT (liter/liter)
MCV = MEAN CORPUSCULAR VOLUME (femtoliter)
MCH = MEAN CORPUSCULAR HEMOGLOBIN (pg)
MCHC = MEAN CORPUSCULAR HEMOGLOBIN CONCENTRATION (gram/deciliter)
RDWc = (%)
PLT = PLATELETS (×10\hat{ }9/liter)
PCV (packed cell volume) = (%)
MPV (mean corpuscular volume) = femtoliter
Na+ = SODIUM (mmol/liter)
K+ = POTASSIUM (mmol/liter)
CO2 = CARBON DIOXIDE (mmHg)
CK = CREATINE KINASE (International Units/liter)
GLU = GLUCOSE (mmol/liter)
CA++ = CALCIUM (mmol/liter)
BUN = BLOOD UREA NITROGEN (mmol/liter)
CRE = CREATININE (μmol/liter)
AST = ASPERTATE AMINO TRANSFERASE (Units/liter)
TBIL = TOTAL BILIRUBEN (μmol/liter)
GGT = GAMMA GLUTAMIEL TRANSFERASE (Units/liter)
ALB = ALBUMIN (gram/liter)
TP = TOTAL PROTEIN (gram/liter)
GLOB = GLOBULIN (gram/liter)

Blood tests were also conducted for three horses to determine when transdermal ozone therapy should be provided. The horses were Shamon, Pauli and Sinbad. The blood tests were conducted immediately before transdermal ozone therapy and immediately thereafter. For the horse Shamon, blood tests were also conducted 12 hours and 24 hours after transdermal ozone therapy. The results are shown in Table 2. It will be noted that the Na⁺, K⁺ and Cl⁻ blood concentrations all remained within normal ranges as indicated in Table 2, indicating that there was no dehydration effect on the horses as a result of the transdermal ozone therapy.

TABLE 2
BLOOD OXYGEN TESTS

| | First Test | | | | Second Test | |
|---|---|---|---|---|---|---|
| | SHAMON | SHAMON | PAULI | PAULI | SINBAD | SINBAD |
| | PRE-TREAT | POST-TREAT | PRE-TREAT | POST-TREAT | PRE-TREAT | POST-TREAT |
| PO₂ (mmHg) | 40.00 | 52.70 | 39.30 | 49.20 | 35.90 | 48.00 |
| SO₂ (%) | 74.60 | 90.50 | 80.30 | 87.10 | 70.60 | 86.40 |
| Na⁺ (150.0-133.0 mmol/L) | 136.00 | 148.30 | 143.00 | 144.30 | 147.40 | 150.20 |
| K⁺ (5.3-3.0 mmol/L) | 3.41 | 4.09 | 3.73 | 4.37 | 3.49 | 3.04 |
| Cl⁻ (109.0-97.0 mmol/L) | 96.20 | 107.70 | 103.80 | 106.70 | 106.00 | 107.70 |

Diseases and degeneration can be prevented through proper oxygenation of the tissues and organs and many diseases can be prevented, relieved or even cured by re-establishing the delivery of oxygen to the affected areas. A preliminary study conducted on endurance horses using transdermal ozone therapy applied by means of the apparatus 10, has indicated that the ozone therapy has benefit to reduce muscle stiffness caused by long periods of intense exercise. The blood tests conducted showed a marked decrease in the CK and AST levels in horses that presented symptoms of a condition termed “tying-up”. The occurrence of muscle spasms was also significantly reduced in horses treated transdermally with ozone. Other possible benefits of using transdermal ozone therapy in horses is an increase in the white blood cell count, thus improving the disease fighting capability and generally boosting the immune system for optimum functionality. Horses with general fatigue brought on by constant hard work and competition, have also shown to benefit from transdermal ozone therapy, showing a marked improvement in energy levels and stamina. Effective treatment was also noted in horses with billiary, where the haematocrit did not drop down to very low levels, and increased significantly from 31 to 38% after two treatment sessions using the apparatus 10. In non-human mammals, such as horses, transdermal ozone therapy is expected to be helpful in the treatment of conditions such as equine influenza, African horse sickness, skin allergies such as sweet itch and mange, and wounds. It is also expected that the transdermal ozone therapy would assist in treating conditions such as sarcoids and degenerative joint diseases.

1. Apparatus for treating an equid or a camel, the apparatus including
an enclosure having an interior within which the body of an equid or a camel can be located, the enclosure having an opening through which the head of the equid or camel can pass so that the head of the equid or camel can be located outside the enclosure when the body of the equid or camel is inside the enclosure, and the enclosure being sized to allow the equid or camel to stand normally on the four legs of the equid or camel, or to lie down, inside the enclosure during treatment;
a steam generator arranged to feed steam into the enclosure; and
an ozone generator or supply arranged to feed ozone into the enclosure.

2. The apparatus as claimed in claim 1, which includes a displaceable barrier or closure operable to fit around the neck of the equid or camel to screen off the interior of the enclosure from the head of the equid or camel, thereby inhibiting inhaling of ozone by the equid or camel.

3. The apparatus as claimed in claim 2, in which the barrier or closure is of a flexible material.

4. The apparatus as claimed in claim 1, in which the enclosure includes a door at an end thereof to admit an equid or a camel to be treated, the door being located in an opening sized and configured to allow an equid or a camel to walk into the enclosure.

5. The apparatus as claimed in claim 1, in which the enclosure includes a displaceable roof to admit an equid or a camel.

6. The apparatus as claimed in claim 5, in which the displaceable roof is hingedly attached to a side of the enclosure to pivot about a substantially horizontal axis.

7. The apparatus as claimed in claim 1, in which the enclosure is sized to accommodate a standing adult horse.

8. The apparatus as claimed in claim 1, in which the enclosure is housed within a closeable housing.

9. The apparatus as claimed in claim 8, in which at least some walls of the closeable housing are spaced from the enclosure to define component spaces within which components of the apparatus are located.

10. The apparatus as claimed in claim 1, in which the enclosure is supported on a wheeled chassis, rendering the apparatus mobile.

11. The apparatus as claimed in claim 1, in which the steam generator includes at least one steam inlet at a low elevation inside the enclosure in use to feed steam at a low elevation below the body of the equid or camel into the enclosure.

12. The apparatus as claimed in claim 1, in which the steam generator includes a temperature controller operable automatically to control the temperature inside the enclosure by manipulating the flow of steam into the enclosure, the steam controller including at least one temperature sensor inside the enclosure located at a high elevation inside the enclosure so that in use the temperature sensor is above the body of the equid or the camel inside the enclosure.

13. The apparatus as claimed in claim 1, in which the ozone generator includes a supply of oxygen and at least one ozone inlet at a high elevation inside the enclosure to feed ozone into the enclosure.

14. The apparatus as claimed in claim 13, in which the ozone inlet is located such that in use the ozone inlet is above the body of the equid or camel inside the enclosure.

15. The apparatus as claimed in claim 1, which includes at least one infra-red or far infra-red light source inside the enclosure, in use to illuminate the body of the equid or camel with infra-red or far infra-red light.

16. The apparatus as claimed in claim 1, which includes sprayers inside the enclosure in flow communication with a source of ozonated water to spray ozonated water on the body of the equid or camel.

17. A method of treating a quadruped mammal, the method including locating the mammal's body in an enclosure such that the mammal is standing on its four legs and the mammal's head is outside the enclosure and screened or sealed from the enclosure;
heating an interior of the enclosure with steam; and
feeding ozone into the heated enclosure for a treatment period thereby providing the mammal with transdermal ozone therapy.

18. The method as claimed in claim 17, which includes preheating the enclosure with steam prior to locating the mammal's body inside the enclosure, and in which the steam is saturated steam at atmospheric pressure.

19. The method as claimed in claim 17, in which the mammal is an equid or a camel.

20. The method as claimed in claim 17, in which the interior of the enclosure is heated to a temperature of at least about 39° C.

21. The method as claimed in claim 20, in which the interior of the enclosure is heated to a temperature between about 43° C. and about 47° C.

22. The method as claimed in claim 19, which includes raising the surface body temperature of the equid or camel to a temperature of between about 37° C. and about 41° C., and in which the treatment period is between about 20 minutes and about 60 minutes.

23. The method as claimed in claim 17, which includes illuminating the mammal's body inside the enclosure with infra-red or far infra-red light, and which includes spraying ozonated water on the body of the mammal.
